(19) United States
(12) Patent Application Publication
(10) Pub. No.: US 2013/0094939 A1
(43) Pub. Date: Apr. 18, 2013

(54) IN-PIPE HYDRO TURBINE WITH AIR BUBBLE

(71) Applicants: Daniel Farb, Beit Shemesh (IL); Avner Farkash, Beit Shemesh (IL); Zeev Savion, Beit Shemesh (IL)

(72) Inventors: Daniel Farb, Beit Shemesh (IL); Avner Farkash, Beit Shemesh (IL); Zeev Savion, Beit Shemesh (IL)

(73) Assignee: LEVIATHAN ENERGY HYDROELECTRIC LTD., Beit Shemesh (IL)

(21) Appl. No.: 13/704,618

(22) PCT Filed: Jun. 15, 2011
(86) PCT No.: PCT/IB11/52585

§ 371 Date: Dec. 16, 2012

Related U.S. Application Data
(60) Provisional application No. 61/355,173, filed on Jun. 16, 2010.

(51) Int. Cl. F03B 11/00

(52) U.S. Cl. CPC F03B 11/002
USPC 415/117

(57) ABSTRACT

An in-pipe turbine with the use of an air bubble in a new and unique configuration with electronic controls can improve the efficiency of in-pipe hydroelectric turbines.

This patent application claims the benefit of U.S. Provisional Patent Application No. 61/355,173, Provisional 6-10 Hydro Turbine, filed Jun. 16, 2010.

### FIELD AND BACKGROUND OF THE INVENTION

The present invention relates to systems, devices, and methods for a hydro turbine in a piping system. Such a system can deal with both steady and variable flow, and high and low head.

The essence of the invention is the use of an air bubble within the casing in combination with a control system for the pressure and flow rate in at least one location of the system, and preferably the whole area from the input to the output pipe.

The concept of air bubbles has been suggested before in conjunction with in-pipe turbines but without control systems. Toyama in U.S. Pat. No. 4,488,055 shows an air bubble but without a control system and without the other features shown here, such as a method to keep the blades free of back-pressure from the water. In addition, there is no means to control downstream pressure. This is a crucial point, as specific levels of downstream pressure are required to maintain the integrity of the piping system. The current application addresses that issue.

Another unique characteristic of the current system is that it frees the input fluid nozzle and blade area from fluid that can decrease the amount of energy impinging on the blade. As noted, Toyama has no input nozzle, and no elevation change to keep the fluid away from the input fluid nozzle. The current application describes some systems whereby a small amount of efficiency is sacrificed in order to attain such a situation in return for the much higher efficiency of a blade that faces minimal interference from liquid inside the turbine area.

Note that in this application there is a distinction between the input fluid nozzle, which regulates the shape of the stream entering the turbine blades, and the input air nozzle, which provides air to the system.

Note that Lerner, U.S. Pat. No. 4,731,545, is irrelevant because it is an attachment to a garden hose, not part of a piping system. Furthermore, it does not contain a device for inserting pressurized air.

An earlier patent, Turbine Relationships in Pipes, IB2009/053611, by the author Daniel Farb, claims as follows:

“5. A method of placing turbines in a piping system with a downward section of pipe, wherein the upstream turbine active area is not filled with backed-up content from the downstream turbine.”

The current patent application does not conflict with the previous patent because it describes ways of implementing the method of a fluid-free turbine environment, and the previous patent application specifically states the context of a downward section of pipe in which gravity is the major factor in the separation, not pressure. The current application describes a system that can work in flat as well as downward piping systems.

### BRIEF DESCRIPTION OF THE DRAWINGS

The invention is herein described, by way of example only, with reference to the accompanying drawings, wherein:

FIG. 1 is a diagram of an in-pipe turbine system with an air bubble and pressure differences.

FIG. 2 is a diagram of an in-pipe turbine with an air bubble and needle.

FIG. 3 is a diagram of an in-pipe vertical axis turbine with an air bubble.

FIG. 4 is a diagram of an input fluid nozzle with a needle.

FIG. 5 is a diagram of the needle of an input hydro turbine nozzle.

FIG. 6 is a diagram of the control system.

### DESCRIPTION OF THE PREFERRED EMBODIMENTS

The present invention relates to an invention for the production of electrical power from an in-pipe turbine using an air bubble and pressure controls. According to the present invention, there are provided several devices and methods of a specific hydro turbine approach with the unified aim of addressing the production of power from piping systems. A large number of patents and devices for hydroelectric turbines exist. However there are novel points that are disclosed in the current invention, and they specifically relate to the problems of energy from piping systems.

In this application, sometimes “air” and “gas” and “liquid” and “water” may be used equivalently.

The problem the current application addresses is the effect of water surrounding the turbine in a pipe causing decreased efficiency. Proposed here is a solution to this dilemma. It is to maintain the turbine completely or substantially out of the water or other fluid bathing the turbine. A method of doing so involves the use of pumped air, and includes any devices for delivering it, and particularly directed to maintaining the turbine superior to the fluid.

Any type of turbine, such as the traditional Pelton turbine, can operate more efficiently with this air bubble system.

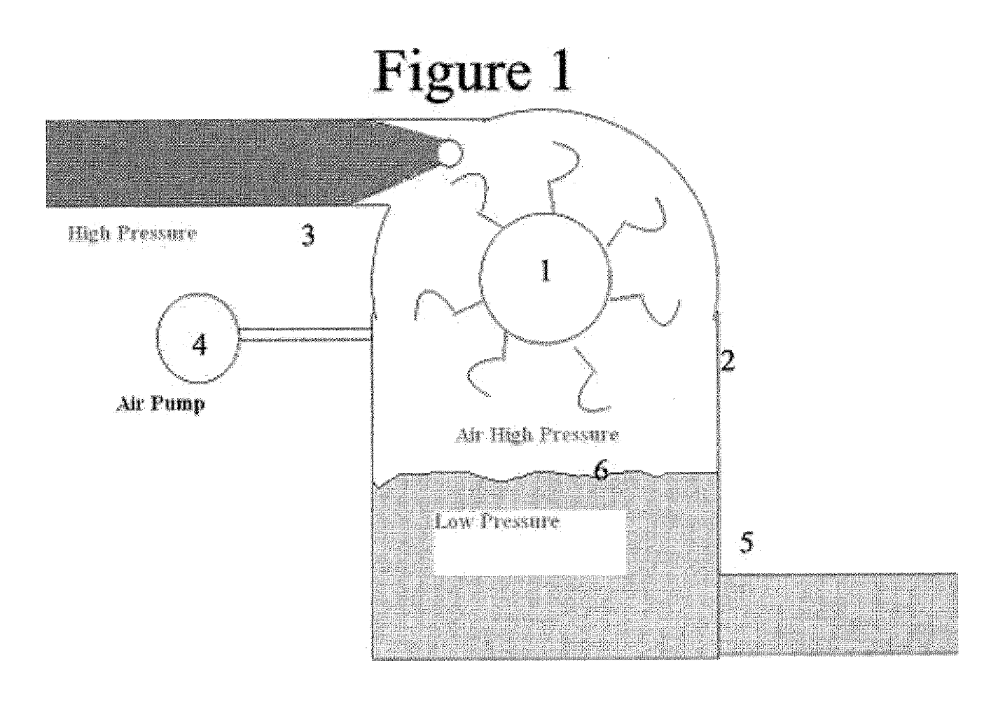

Referring now to the drawings, FIG. 1 illustrates a hydro turbine (1) in a pipe wherein the upper portion is air. (2) is a casing that permits drainage of liquid from the turbine inferiorly before continuing It shows the entry of fluid at the superior part of a turbine (3) where there is high air pressure (6) at the intersection of the air-fluid interface, and the collection of the fluid below at lower pressure (5) as it exits. The novelties are that the system is part of a piping system and is fully enclosed in its vicinity, and that air input (4) is used to keep the turbine free of surrounding fluid. In one embodiment, the supply of air pressure is directed into the cups so as to not detract from the rotational motion. The control of level and pressure can also be mechanical.

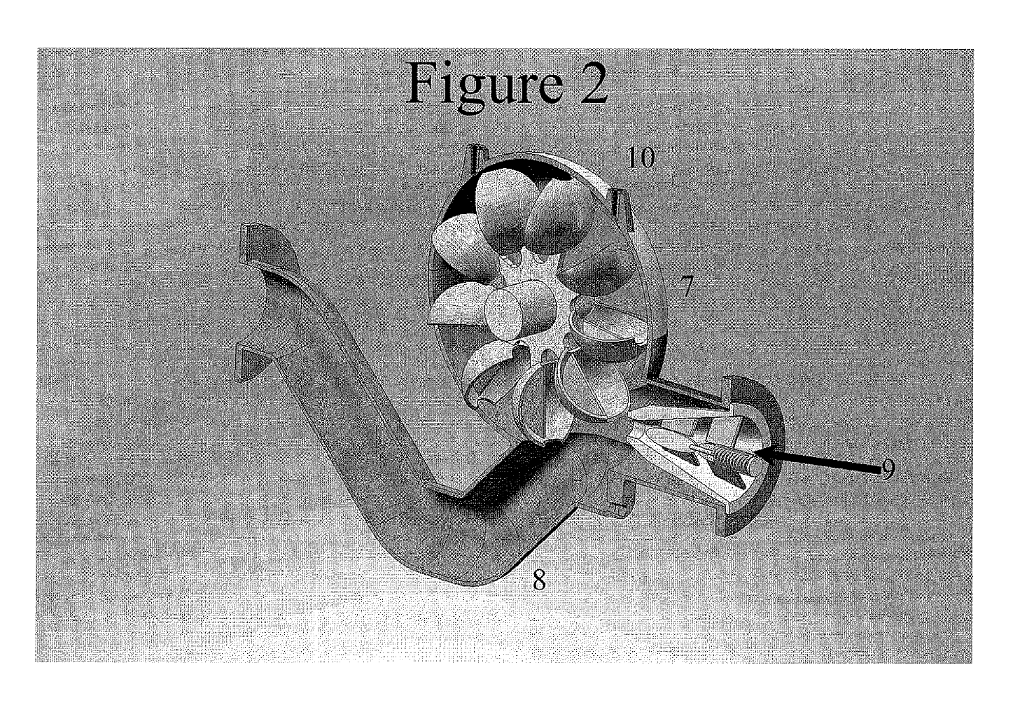

FIG. 2 is a diagram of an in-pipe turbine with an air bubble and needle (9). At the right side is a nozzle with a needle and an optional spring. This part is novel when used in combination with the turbine system (7) as shown. The fluid in the turbine then hits cups in an area supplied by air pressure inlets (10) superiorly. Ideally these inlets aim at the cups as well so as not to retard the rotation. Then the fluid exits the turbine inferiorly (8) and in one embodiment ascends to the left. At the far left is a good location for a one-way valve to ensure flow without backpressure in one embodiment.

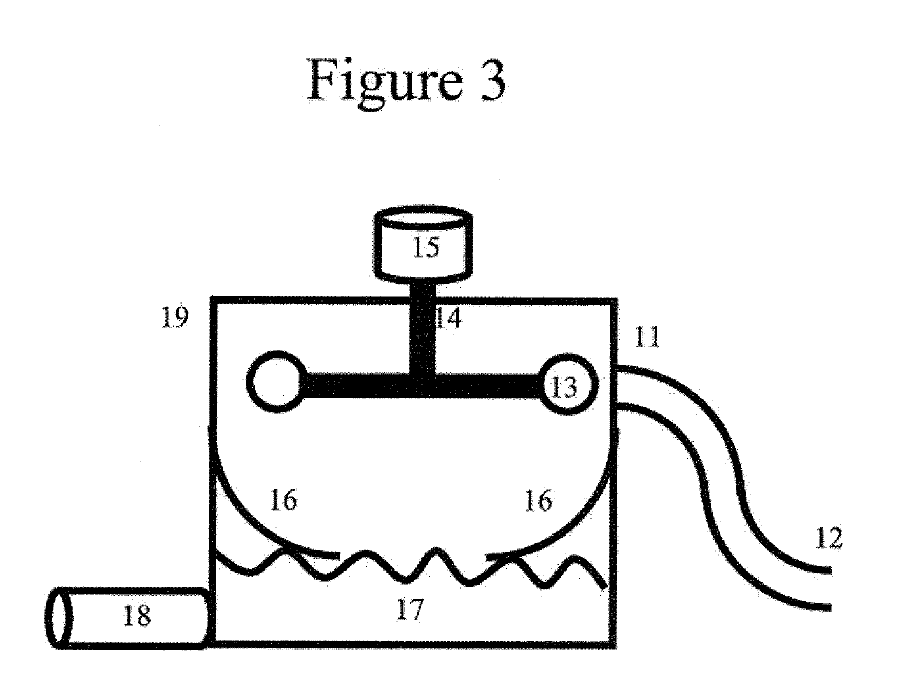

FIG. 3 is a diagram of an in-pipe vertical axis turbine with an air bubble. The liquid enters at input pipe (11) where the input nozzle is located. In one embodiment, the piping system is relatively flat at the level of (12) and the liquid rises to point (11). This can mean a sacrifice of a fraction of an atmosphere of pressure, but in return, it enables a system that can provide high efficiency conversion into power. The casing (19) contains a vertical axis turbine with blades (13), but in other embodiments the turbine can have other configurations. In one embodiment, a shaft (14) connects it to a generator (15). One of the advantages of this configuration is that there is less need for a tightly sealed generator shaft that will cause a loss of energy through friction. An interface blocker (16) or means for creating a separation of the water and air layer reduces the area of interface between the air and the water (17) and thereby requires less energy for the maintenance of the air bubble. An interface blocker can of course also be used with a horizontal axis or other turbine. In one embodiment, said interface blocker can move vertically with the level of the liquid, in one embodiment, by floating, or in another embodiment, by sliding. The output pipe is (18).

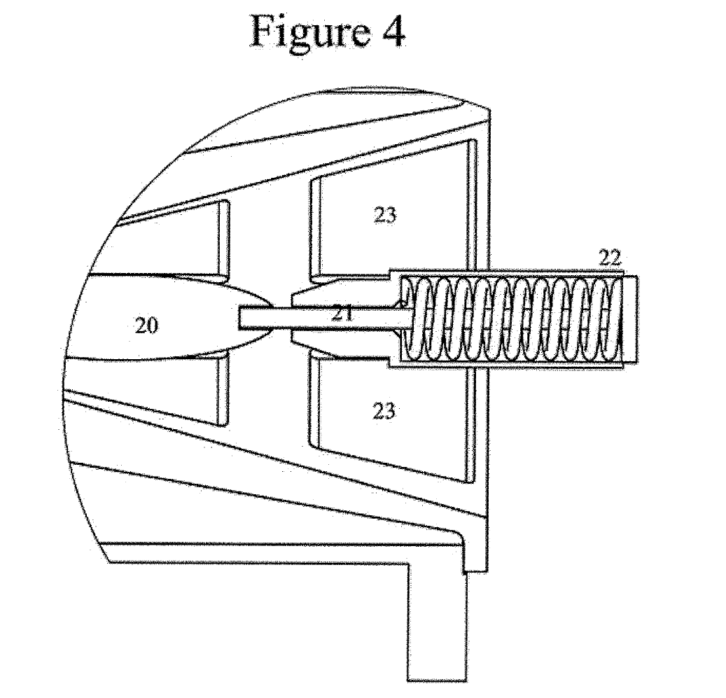

FIG. 4 is a diagram of an input fluid nozzle with a needle. Part (20) is the needle. A shaft piece (21) connects it to a spring or other regulator (22) held in place by peripheral attachments (23).

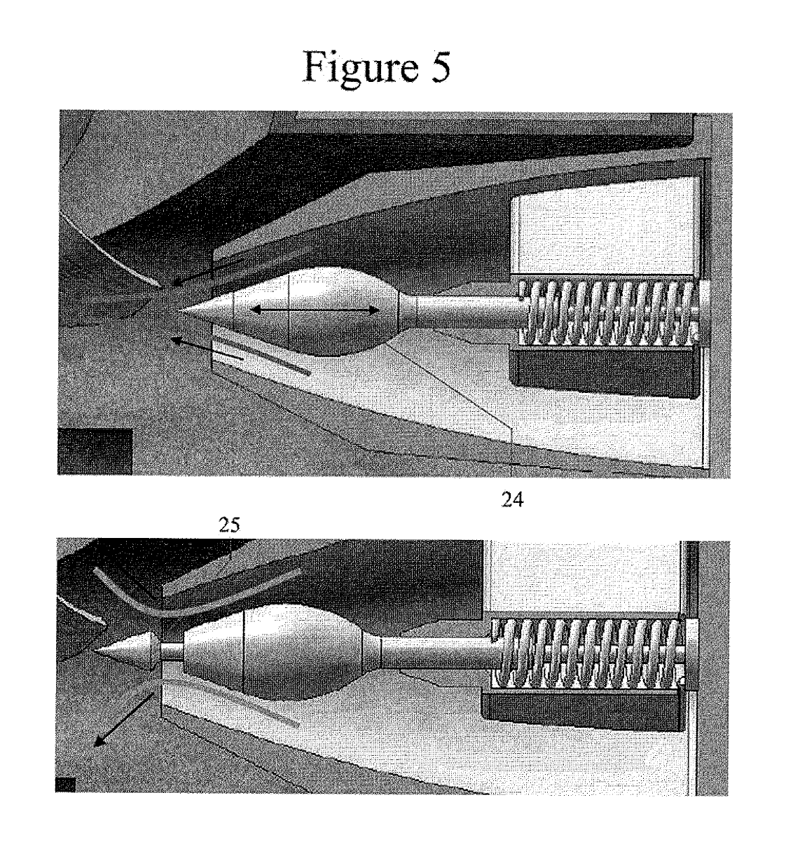

FIG. 5 is a diagram of the needle of an input hydro turbine nozzle. The body of the needle (24) is constructed so that not only can the body itself move back and forth into the nozzle opening, known art in hydroelectric power, but also a portion of the needle (25) can move back and forth in the stream, thereby enabling greater control of variable pressures. The movement of portion (25) allows change of water jet shape in order to reduce or increase the force of its impact on the rotating blades, thereby controlling the mechanical torque and revolutions per minute of the shaft, and it can be used also for braking purposes by diverting the jet from the buckets of the blades.

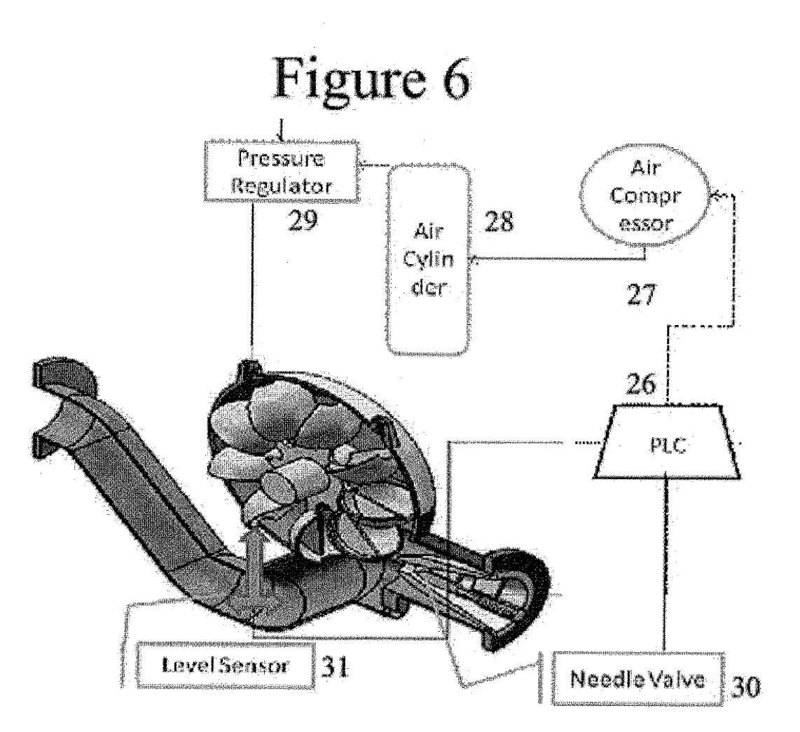

FIG. 6 demonstrates how this can be part of an electronically controlled system through a microprocessor with memory. At the most basic level, the PLC (Programmable Logic Controller) (26) controls the level and the pressure by being connected, in various embodiments and various combinations, to an air compressor (27), an air cylinder (28), a pressure regulator (29), a needle valve (30), and a level sensor (31) to create a pressure regulation system. The position of the needle in one embodiment is controlled by this system. An air compressor is an optional part of this system.

In summary, claims are made for the fluid-free or substantially fluid-free turbine in a casing connected to a pipe, maintained in such a fashion using different combinations of the devices and methods just described.

The methods and devices involve keeping the fluid level at the point of maximum efficiency, in one embodiment by decreasing flow inward as the level rises, and increasing flow in as it falls. Another method and device for operating the system involves adjusting the air pressure in relation to the fluid exit pressure. In one embodiment, in a horizontal section of piping, the entering air pressure would be greater than the fluid exit pressure. In another embodiment, the combination of pipe exit inclination, fluid exit pressure, and air pressure would be controlled as a group in order to assure the exit of the fluid.

While the invention has been described with respect to a limited number of embodiments, it will be appreciated that many variations, modifications and other applications of the invention may be made.

### SUMMARY OF THE INVENTION

The present invention successfully addresses the shortcomings of the presently known configurations by providing an in-pipe hydroelectric turbine with an air bubble under electronic control.

It is now disclosed for the first time a hydroelectric system in a pipe containing a fluid, with a connected generator for electrical output, comprising:

a. A casing enclosing a turbine with at least one blade and connected to at least one input and output pipe,
b. A gas pressure means providing substantially continuous gas pressure to the interior of the casing through at least one gas nozzle, operative to keep the turbine blades substantially free of back-flow water.

In one embodiment, the system further comprises:

c. A water level sensor downstream from the turbine.

In one embodiment, the system further comprises:

c. A system operative to maintain output pressure at 1 atmosphere or greater.

In one embodiment, the system further comprises:

c. Blades with a depression facing inferiorly, operative to direct at least some of the water inferiorly after striking the blade.

In one embodiment, the system further comprises:

c. A liquid-gas interface area-reducing means inside the casing downstream from the turbine blades, whereby the area of interface between the liquid and the gas is reduced.

According to another embodiment, the said interface area-reducing means can change vertical level in accordance with the level of the fluid.

In one embodiment, the system further comprises:

c. One-way valves downstream from the turbine combined with re-pressurization of the contents.

In one embodiment, the system further comprises:

c. A microprocessor control system operative to regulate the upstream and/or downstream pressure and/or upstream or downstream flow rate by using input from at least one sensor.

According to another embodiment, at least one gas nozzle is directed towards the blade inner surface, for the purpose of removing liquid, before it rotates into position to receive the fluid from the input gas nozzle.

In one embodiment, the system further comprises:

c. An input fluid nozzle needle system comprising an upstream part, which contains a means to move in the orientation of the fluid flow, and a downstream part that can separate from the upstream part in the orientation of fluid flow.
According to another embodiment, the input fluid nozzle needle system can also expand its diameter.

In one embodiment, the system further comprises:

c. An upstream elevation of the level of the input pipe adjacent to the casing.

In one embodiment, the system further comprises:

c. A depression in the elevation of the casing or piping downstream to the turbine from the entrance point to the casing.

According to another embodiment, the turbine is in a vertical axis.

In one embodiment, the system further comprises:

c. An upstream elevation of the level of the input pipe adjacent to the casing.

In one embodiment, the system further comprises:

c. A downstream one-way valve.

In one embodiment, the system further comprises:

c. A compressor means operative to re-pressurize the output liquid.

According to another embodiment, at least one turbine blade has a hydrophobic coating.

It is now disclosed for the first time a method of keeping the blades of an in-pipe turbine system in a casing substantially free of water by the steps of

a. Placing a microprocessor control system to regulate the pressure in the system with at least one of the following set of connected components: liquid level sensor, liquid pressure sensor, gas pressure sensor, gas compressor, and needle valve system,
b. Introducing an air bubble into the casing.

In one embodiment, the system further comprises: the step of:

c. Providing a gas/downstream water interface area reduction means.

What is claimed is:

1. A hydroelectric system in a pipe containing a fluid, with a connected generator for electrical output, comprising:
a. A casing enclosing a turbine with at least one blade and connected to at least one input and output pipe,
b. A gas pressure means providing substantially continuous gas pressure to the interior of the casing through at least one gas nozzle, operative to keep the turbine blades substantially free of back-flow water.

2. The system of claim 1, further comprising:
c. A water level sensor downstream from the turbine.

3. The system of claim 1, further comprising:
c. A system operative to maintain output pressure at 1 atmosphere or greater.

4. The system of claim 1, further comprising:
c. Blades with a depression facing inferiorly, operative to direct at least some of the water inferiorly after striking the blade.

5. The system of claim 1, further comprising:
c. A liquid-gas interface area-reducing means inside the casing downstream from the turbine blades, whereby the area of interface between the liquid and the gas is reduced.

6. The system of claim 5, wherein the said interface area-reducing means can change vertical level in accordance with the level of the fluid.

7. The system of claim 1, further comprising:
c. One-way valves downstream from the turbine combined with re-pressurization of the contents.

8. The system of claim 1, further comprising:
c. A microprocessor control system operative to regulate the upstream and/or downstream pressure and/or upstream or downstream flow rate by using input from at least one sensor.

9. The system of claim 1, wherein at least one gas nozzle is directed towards the blade inner surface, for the purpose of removing liquid, before it rotates into position to receive the fluid from the input gas nozzle.

10. The system of claim 1, further comprising:
c. An input fluid nozzle needle system comprising an upstream part, which contains a means to move in the orientation of the fluid flow, and a downstream part that can separate from the upstream part in the orientation of fluid flow.

11. The system of claim 10, wherein the input fluid nozzle needle system can also expand its diameter.

12. The system of claim 1, further comprising:
c. An upstream elevation of the level of the input pipe adjacent to the casing.

13. The system of claim 1, further comprising:
c. A depression in the elevation of the casing or piping downstream to the turbine from the entrance point to the casing.

14. The system of claim 1, wherein the turbine is in a vertical axis.

15. The system of claim 14, further comprising:
c. An upstream elevation of the level of the input pipe adjacent to the casing.

16. The system of claim 1, further comprising:
c. A downstream one-way valve.

17. The system of claim 1, further comprising:
c. A compressor means operative to re-pressurize the output liquid.

18. The system of claim 1, wherein at least one turbine blade has a hydrophobic coating.

19. A method of keeping the blades of an in-pipe turbine system in a casing substantially free of water by the steps of
a. Placing a microprocessor control system to regulate the pressure in the system with at least one of the following set of connected components: liquid level sensor, liquid pressure sensor, gas pressure sensor, gas compressor, and needle valve system,
b. Introducing an air bubble into the casing.

20. The method of claim 19, comprising the step of:
c. Providing a gas/downstream water interface area reduction means.
